(19) United States
(12) Patent Application Publication
(10) Pub. No.: US 2017/0192985 A1
(43) Pub. Date: Jul. 6, 2017

(54) DECORATING WEBPAGE LINKS WITH A USER-SPECIFIED INDICATOR

(71) Applicant: International Business Machines Corporation, Armonk, NY (US)

(72) Inventors: Stephen M. Fontes, Cary, NC (US); J. Peter Neergaard, Pittsburgh, PA (US)

(21) Appl. No.: 14/986,805

(22) Filed: Jan. 4, 2016

(51) Int. Cl. G06F 17/30; G06F 3/0484; G06F 17/22; G06F 3/0481

(52) U.S. Cl. CPC G06F 17/3089; G06F 3/04817; G06F 3/04812; G06F 3/04847; G06F 17/2247; G06F 17/2235

(57) ABSTRACT

A computer implemented method for decorating webpage links is provided. The computer implemented method displays a user-selectable icon via a display interface in response to the displaying of a webpage via the display interface. The computer implemented method prompts a user to specify an indicator indicative of a relevance of the webpage, in response to a user-selection of the user-selectable icon.

### BACKGROUND

The present invention relates to methods and a system to decorate webpage links with a user-specified indicator.

Webpage browsers display links to previously visited pages in a different color. The different color provides a user of the webpage browser with a visual cue as to whether the webpage has been previously visited. The webpage user frequently revisits webpages related to the same search or research task. Some webpages that have been previously visited may have valuable information or may have information not relevant to the search or research task. The single color visual cue does not distinguish between pages that contain valuable information and pages that contain information that may not be as relevant or useful to the search or research task.

### SUMMARY

According to an embodiment of the present invention, a computer implemented method for associating relevance with web pages, and using the relevance for decorating webpage links is provided. The computer implemented method displays a user-selectable icon via a display interface in response to the displaying of a webpage via the display interface. The computer implemented method prompts a user to specify an indicator indicative of a relevance of the webpage, in response to a user-selection of the user-selectable icon. The computer implemented method stores the indicator into local memory. The computer implemented method uses the stored relevance to decorate webpage links with the indicator.

According to another embodiment of the present invention, a system for decorating webpage links is provided. The system includes at least one processor programmed to output for display a webpage and output for display a user-selectable icon. The at least one processor is further programmed to output for display indicators available to create a user-defined indicator associated with a link to the webpage, the indicator specifying a user-determined relevance of the webpage, in response to a first user-selection of the user-selectable icon. The at least one processor is further programmed to store the user-defined indicator into memory. The at least one processor is further programmed to output for display the user-defined indicator proximate a link to the webpage in response to the display of the link to the webpage.

According to yet another embodiment of the present invention, a computer program product for implementing a method of decorating webpage links is provided. The computer program product comprises a computer readable storage medium having program instructions executable by a processor to perform a method. The method displays a plurality of first search results via a display interface based on a first search query or a webpage link. The method displays a webpage and a user-selectable icon via a display interface. The method prompts a user to specify an indicator indicative of a user-specified relevance of the webpage and outputs for display a dialog box that receives user data associated with the webpage in response to a user-selection of the user-selectable icon. The method stores the indicator and the dialog box. The method displays the indicator proximate a link to the webpage in response to the display of the link to the webpage.

### BRIEF DESCRIPTION OF THE DRAWINGS

FIG. 1 is an illustrative view of a system for decorating webpage links according to an embodiment of the present invention;

FIG. 2 is an illustrative view of a screen of a display interface of the system for decorating webpage links according to an embodiment of the present invention;

FIG. 3 is a further illustrative view of the screen of the display interface of the system for decorating webpage links according to an embodiment of the present invention; and

FIG. 4 is a flowchart of a computer implemented method for decorating webpage links according to an embodiment of the present invention.

### DETAILED DESCRIPTION

As stated above, the present invention relates to a computer implemented method, a computer program product, and a method for associating relevance or a rating with web pages, and using the relevance or rating for decorating webpage links, which are now described in detail with the accompanying figures. It is noted that like reference numerals refer to like elements across different embodiments.

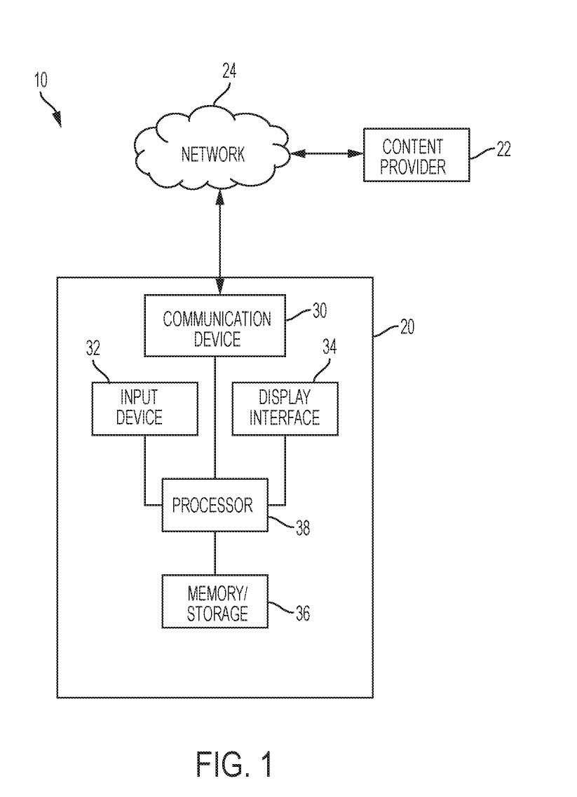

Referring to FIG. 1 a block diagram of a system 10 for decorating webpage links is shown. The system 10 includes an electronic computing device 20 in communication with a content provider 22 through a network 24. The electronic computing device 20 is a personal computing device, a mobile device, or the like having connectivity with the network 24. The network 24 includes communication channels for exchanging data such as the Internet, an extranet, an intranet, a local area network, a wide area network, near field communications, satellite or wireless communications, or the like.

The content provider 22 sends information such as content data, metadata, or search results to the electronic computing device 20 via the network 24. The content provider 22 includes a server or the like configured to receive data requests from the electronic computing device 20 and provide appropriate or otherwise relevant data or metadata in response to the data requests. The server includes webpage content, webpage information, email data, or the like.

The electronic computing device 20 includes a communication device 30, an input device 32, a display interface 34, and a computer readable storage medium 36 all of which are in communication with at least one processor 38. In at least one embodiment, the communication device 30 is a transceiver that places the electronic computing device 20 in communication with data sources or data requesters directly or through the network 24.

The input device 32 is a mechanism that permits a user of the electronic computing device 20 to input information into the electronic computing device 20. The input device 32 is a human machine interface. The input device is a keyboard, a mouse, a pointer, a microphone, a voice recognition device, a biometric device, or the like.

The display interface 34 is a mechanism that enables the electronic computing device 20 to output for display information to a user of the electronic computing device 20. The display interface 34 includes a screen, a speaker or other auditory output device, a haptic device, a touchscreen, a visual display, a graphical user interface, or the like.

The at least one processor 38 is in communication with or connected to the computer readable storage medium 36. The computer readable storage medium 36 includes at least one of a non-persistent storage and a persistent storage. In at least one embodiment, the non-persistent storage is a random-access memory and the persistent storage is a hard disk drive or flash memory. The computer readable storage medium 36 embodies a computer program product for associating relevance or a rating with web pages, and using the relevance or the rating for decorating webpage links. The computer program product embodies executable program instructions that are executable by the at least one processor 38 to perform the operations of the executable program instructions.

The at least one processor 38 is configured to or programmed to download information or content from the content provider 22. The downloaded information or content from the content provider 22 is displayed as a webpage by a web browser 50 via the display interface 34.

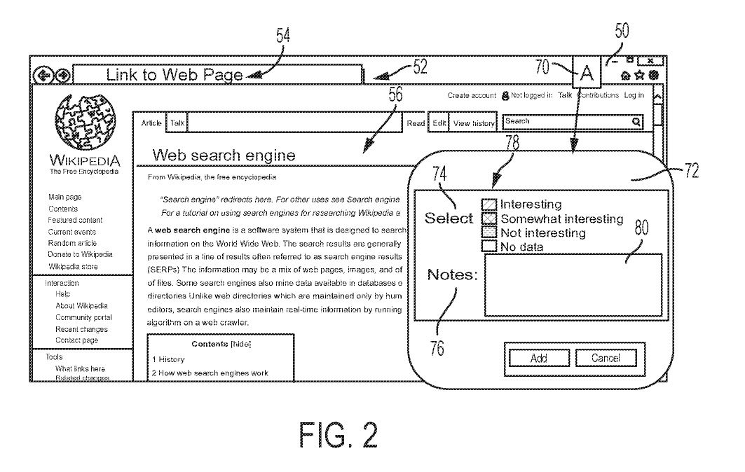

Referring to FIG. 2, a screen of a display interface 34 displays an address bar 52 via the web browser 50. A user of the electronic computing device 20 inputs a desired search query or webpage link into the address bar 52 or a search tool of the web browser 50.

The user of the electronic computing device 20 inputs a search query or a webpage link 54, into the address bar 52 or the search tool of the web browser 50. The at least one processor 38 outputs for display via the display interface 34 through the web browser 50, a webpage 56 based on the search query or a webpage link 54. In at least one embodiment, the at least one processor 38 outputs for display via the display interface 34 a plurality of search results. The plurality of search results may contain webpage links to information that a user of the electronic computing device 20 deems relevant or not relevant to the research topic. The user of the electronic computing device 20 is unable to evaluate the relevance or irrelevance of a search result of the plurality of search results or subsequent search results without first accessing the link and viewing the webpage associated with the search results.

The at least one processor 38 outputs for display via the display interface 34 through the web browser 50, the webpage 56 or a user-selected search result in response to the user of the electronic computing device 20 selecting a user-selected search result.

The webpage link 54 or the user-selected search result may include an annotation. The annotation may be a bookmark or the like that is added by user or automatically by the web browser 50 or a web browser plug-in after the user of the electronic computing device 20 views the webpage 56. These annotations are not helpful in deciding whether a search result of the plurality of search results or a webpage link 54 is useful to the user of the electronic computing device 20.

The user of the electronic computing device 20 is able to store the useful links as a bookmark. Bookmarks are generally not useful in providing information about the links or webpages attached to the links that a user of the electronic computing device 20 intends to revisit. The computer implemented program product for implementing a method of decorating search results executable by the at least one processor 38 to enable the user of the electronic computing device 20 to filter out links that the user does not intend to bookmark but has previously visited. The computer implemented program product provides the user with a visual indicator that indicates a user-determined value or rating of the webpage and indicates user provided information as to the relevance to the research topic or related research topic input as a search query into the address bar 52 of the web browser 50.

The at least one processor 38 outputs for display a user-selectable icon 70 via the display interface 34 through the web browser 50. The user-selectable icon 70 may be displayed in response to the user of the electronic computing device 20 selecting a search result of the plurality of search results or the display of the webpage 56 associated with the webpage link 54. For example, the user-selectable icon 70 is substantially simultaneously output for display with the webpage 56. In at least one embodiment, the user-selectable icon 70 is continuously displayed as an icon or item within the web browser 50, such as a toolbar item or drop-down menu item.

The user-selectable icon 70 is configured to prompt the at least one processor 38 to output for display a context menu 72. The context menu 72 enables the user of the electronic computing device 20 to specify a relevance level of the webpage 56 associated with the webpage link 54 or the webpage link associated with the user-selected search result as well as to provide a description of the webpage that includes a description of the relevance of the user-selected search result. The at least one processor 38 outputs for display via the display interface through the web browser 50 the context menu 72, in response to a first user-selection of the user-selectable icon 70.

The context menu 72 includes a first portion 74 that displays indicators available to create a user-defined indicator 78 associated with the webpage link 54 associated with the webpage 56 or the user-selected search result. The indicators available to create the user-defined indicator 78 output for display within the first portion 74 enables the user of the electronic computing device 20 to indicate the relevance of the webpage link 54 associated with the webpage 56 or the user-selected search result. The relevance is capable of being specified multiple ways that include but are not limited to a color-coded shape (as shown in FIG. 2), a thumbs up/thumbs down indicator, a star rating system, the like, or a combination thereof.

The context menu 72 includes a second portion 76 that displays a dialog box 80 capable of receiving user input text, user input information, user input notes, a webpage description, or user data associated with the webpage link 54 associated with the webpage 56 or the user-selected search result. The text or user input data are capable of being input into the dialog box 80 to create a note that describes the webpage 56 or provides information as to the relevance of the webpage 56 associated with webpage link 54 or the user-selected search result.

In at least one embodiment, the context menu 72 is output for display in response to a user of the electronic computing device 20 right clicking on the webpage 56 or other methods that may result in the context menu 72 being displayed within the web browser 50. The context menu 72 is provided by a plug-in associated with the web browser 50 that enables the user to quickly tag webpage links or webpages displayed within the web browser 50 with the user-defined indicator 78 associated with the webpage link 54 and/or with the dialog box 80 describing the webpage 56.

In at least one embodiment, in response to receiving the first user-selection of a user-defined indicator 78 of the indicators available specifying the user-determined or user specified relevance of the webpage link 54 associated with the webpage 56 or the user-selected search result, the at least one processor 38 stores the user-defined indicator 78 and/or the text entered into the dialog box 80 into memory such as the computer readable storage medium 36. This information may be stored as metadata or in a shareable format such that the user of the electronic computing device 20 is able to share or export the metadata. The information is stored in a user's personal storage and is the user's individual relevance rating and is not necessarily an aggregated rating from other users concerning the relevance of the webpage 56.

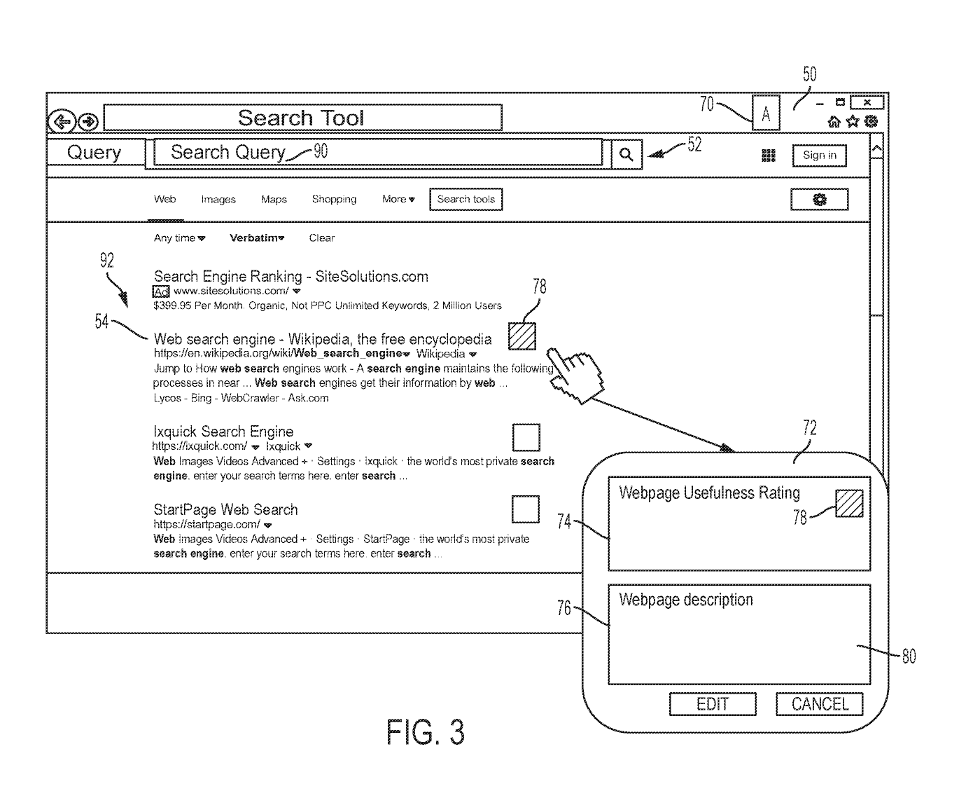

Referring to FIG. 3, the user of the electronic computing device 20 may desire to conduct a search query 90. The search query 90 is input into the address bar 52 of the search tool of the web browser 50. The at least one processor 38 outputs for display via the display interface 34 through the web browser 50, a plurality of search results 92 based on the search query 90. The plurality of search results 92 contains information that overlaps with the plurality of search results.

The at least one processor 38 is programmed to search the plurality of search results 92 for webpage links that the user of the electronic computing device 20 has previously viewed. The at least one processor 38 is programmed to output for display the user-defined indicator 78 proximate the webpage link 54 associated with the webpage 56 or associated with the user-selected search result, in response to a display of the webpage link 54 of the webpage 56 via the display interface 34. In at least one embodiment, the user-defined indicator 78 is displayed proximate a webpage link 54 associated with the webpage 56 as it is displayed in computer programs besides the web browser 50, such as emails, blogs, documents, or the like.

The display of the user-defined indicator 78 proximate the webpage link 54 associated with the webpage 56 enables the user of the electronic computing device 20 to assess the relevance of the webpage link 54 associated with the webpage 56 of the user-selected search results without viewing the webpage 56.

The at least one processor 38 is programmed to output for display the user-defined indicator 78 proximate a search result of the plurality of search results 92 that a user of the electronic computing device 20 has not viewed or has not provided relevance information into. Such an indicator is displayed as an empty or non-color-coded user-defined indicator 78 box.

The at least one processor 38 is programmed to output for display the context menu 72 in response to a user of the electronic computing device 20 disposing a cursor or other pointer device proximate the user-defined indicator 78. The context menu 72 provides information as to the user-defined or user-specified relevance of the webpage link 54 associated with the webpage 56 and any notes or user input data entered into the dialog box 80.

The at least one processor 38 is programmed to output for display the indicators available to modify the user-defined indicator 78, in response to a second user-selection of the user-defined indicator 78. The second user-selection of the user-defined indicator 78 outputs for display the context menu 72 that displays indicators available to create the user-defined indicator 78 associated with the webpage link 54 associated with the webpage 56 or the user-selected search result. The second user-selection of the user-defined indicator 78 outputs for display the dialog box 80 to edit the note or user input data that describes the webpage 56 or provides information as to the relevance of the webpage 56. The at least one processor 38 stores the modified indicator or the modified user-defined indicator 78 and/or the modified dialog box 80.

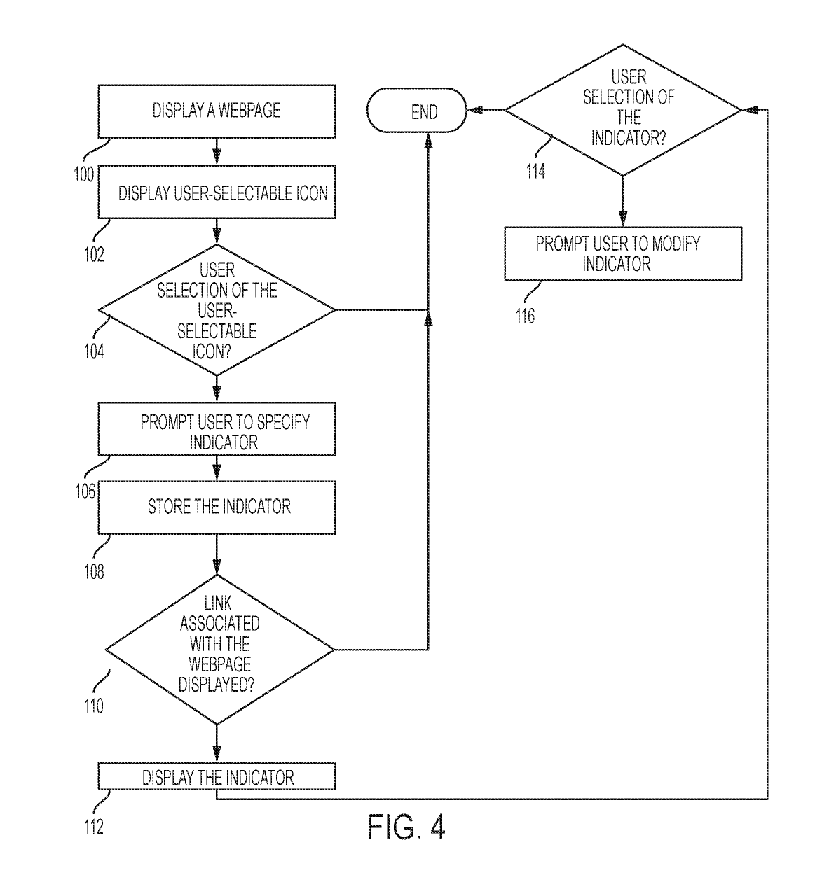

Referring to FIG. 4, a flowchart of a computer implemented method for associating relevance with web pages, and using the relevance for decorating webpage links according to an embodiment of the present invention is shown. The at least one processor 38 is programmed to perform the steps outlined below.

At block 100, the method outputs for display a webpage 56 a webpage link 54. At block 102, the method outputs for display a user-selectable icon 70. The user-selectable icon 70 is output for display via the display interface 34.

At block 104, the method determines if a user of the electronic computing device 20 selects the user-selectable icon 70. Should the user of the electronic computing device 20 not select the user-selectable icon 70, the method may end. If the user of the electronic computing device 20 selects the user-selectable icon 70, the method continues to block 106.

At block 106, the method outputs for display a context menu 72. The context menu 72 prompts a user of the electronic computing device 20 to specify an indicator indicative of a relevance of the webpage 56 or a user-selected search result from a list of available indicators. In response to a user of the electronic computing device 20 specifying an indicator indicative of a relevance of the webpage 56 or the user-selected search result, the method outputs for display the user-defined indicator 78. The context menu 72 also prompts a user of the electronic computing device 20 to input user data associated with the webpage 56 into a dialog box 80 displayed as part of the context menu 72.

At block 108, the method stores the user-defined indicator 78 and the dialog box 80 containing user input data into memory.

At block 110, the method determines if the webpage link 54 associated with the webpage 56 is displayed via the display interface 34. The webpage link 54 associated with the webpage 56 may be associated with a search query. Should the webpage link 54 associated with the webpage 56 not be displayed, the method may end. If the webpage link 54 associated with the webpage 56 is displayed, the method continues to block 112.

At block 112, the method outputs for display the user-defined indicator 78 proximate the webpage link 54 associated with the webpage 56. The user-defined indicator 78 is displayed via the display interface 34. In response to a user cursor or other user directed object being disposed proximate the user-defined indicator 78, the method displays the context menu 72 that includes the user-defined indicator 78 and the dialog box 80.

At block 114, the method determines if the user of the electronic computing device 20 selects the user-defined indicator 78. Should the user of the electronic computing device 20 not select the user-defined indicator 78, the method may end. If the user of the electronic computing device 20 selects the user-defined indicator 78 the method continues to block 116. At block 116, the method prompts the user of the electronic computing device 20 to modify at least one of the user-defined indicator 78 and the dialog box 80. Subsequent to the modification of at least one of the user-defined indicator 78 and the dialog box 80, the modified user-defined indicator and the modified dialog box are stored into memory.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for decorating webpage links, the computer implemented method comprising:
in response to a display of a webpage via a display interface, displaying a user-selectable icon via the display interface; and
in response to a user-selection of the user-selectable icon, prompting a user to specify an indicator indicative of a relevance of the webpage.

2. The computer implemented method of claim 1, further comprising: storing the indicator.

3. The computer implemented method of claim 2, further comprising:
in response to a display of a link to the webpage via the display interface, displaying the indicator proximate the link.

4. The computer implemented method of claim 3, wherein in response to a user cursor disposed proximate the indicator, displaying a dialog box.

5. The computer implemented method of claim 4, wherein the dialog box includes user input information associated with the webpage.

6. The computer implemented method of claim 3, further comprising in response to a user-selection of the indicator, prompting a user to modify the indicator.

7. A system for decorating webpage links, comprising:
at least one processor programmed to:
output for display a webpage;
output for display a user-selectable icon; and
in response to a first user-selection of the user-selectable icon, output for display indicators available to create a user-defined indicator associated with a link to the webpage specifying a user-determined relevance of the webpage.

8. The system of claim 7, wherein the at least one processor is further programmed to store the user-defined indicator.

9. The system of claim 7, wherein the at least one processor is further programmed to, in response to the first user-selection of the user-selectable icon, output for display a dialog box that receives user input data.

10. The system of claim 9, wherein the at least one processor is further programmed to store the dialog box.

11. The system of claim 10, wherein the at least one processor is further programmed to, in response to a display of a link to the webpage, output for display the user-defined indicator proximate the link to the webpage.

12. The system of claim 11, wherein the at least one processor is further programmed to, in response to a second user-selection of the indicator, output for display the indicators available to modify the user-defined indicator.

13. The system of claim 12, wherein the at least one processor is further programmed to, store a modified indicator.

14. The system of claim 12, wherein the at least one processor is further programmed to, in response to the second user-selection of the indicator, output for display the dialog box to modify the user input data.

15. The system of claim 14, wherein the at least one processor is further programmed to, store a modified dialog box.

16. A computer program product for implementing a method of decorating webpage links, the computer program product comprising a computer readable storage medium having program instructions embodied therewith, the program instructions executable by at least one processor programmed to perform the method including:
displaying a webpage via a display interface;
displaying a user-selectable icon via the display interface; and
in response to a user-selection of the user-selectable icon
prompting a user to specify an indicator indicative of a user-specified relevance of the webpage, and
outputting for display a dialog box that receives user data associated with the webpage.

17. The computer program product of claim 16, further comprising storing the indicator and the dialog box.

18. The computer program product of claim 17, further comprising
in response to displaying a link to the webpage, displaying the indicator proximate the link to the webpage.

19. The computer program product of claim 18, wherein in response to a user cursor disposed proximate the indicator, displaying the dialog box.

20. The computer program product of claim 18, further comprising, in response to a user-selection of the indicator, prompting a user to modify at least one of the indicator and the dialog box.
